(19) United States
(12) Patent Application Publication
(10) Pub. No.: US 2025/0014402 A1
(43) Pub. Date: Jan. 9, 2025

(54) BATTERY-POWERED GATEWAY FOR ENABLING LOCATION-BASED ACCESS CONTROL BY AN ACCESS CONTROL SERVER

(71) Applicant: ASSA ABLOY Global Solutions AB, Stockholm (SE)

(72) Inventors: Marko Ovaska, Helsinki (FI); Virve Piiroinen, Joensuu (FI); Miika Heinonen, Helsinki (FI)

(21) Appl. No.: 18/710,295

(22) PCT Filed: Nov. 17, 2022
(86) PCT No.: PCT/EP2022/082284

§ 371 Date: May 15, 2024

(30) Foreign Application Priority Data
Nov. 26, 2021 (SE) 2151445-0
Nov. 26, 2021 (SE) 2151446-8

(51) Int. Cl. G07C 9/00; H04W 4/029

(52) U.S. Cl. CPC G07C 9/00309; H04W 4/029

(57) ABSTRACT

A gateway for enabling remote access control by an access control server for an electronic lock, wherein the gateway comprises: a battery being a power source for the gateway; a short-range radio communication module for communicating with the electronic lock; a communication module for communicating with the access control server; a location determination module; a processor; and a memory storing instructions that, when executed by the processor, cause the gateway to: transmit uplink location data to the access control server, wherein the uplink location data comprises the first location data; receive an unlock message from the access control server; transmit an unlock command to the electronic lock; and transition from an active state to a low-power state.

### TECHNICAL FIELD

The present disclosure relates to the field of gateways and in particular to gateways for communication between an electronic lock and an access control server.

### BACKGROUND

Locks and keys are evolving from the traditional pure mechanical locks. These days, electronic locks are becoming increasingly common. For electronic locks, no mechanical key profile is needed for authentication of a user. The electronic lock can be opened on command from a remote access control server, or the electronic lock can be opened using an electronic key stored on a special carrier (fob, card, etc.) or in a smartphone. Such electronic locks provide a number of benefits, including improved flexibility in management of access rights, audit trails, key management, etc.

There are low-power electronic locks that have additional advantages, e.g. battery-powered, vehicle-powered (from road vehicle, ship, train, airplane, etc.). When the lock is battery-powered, installation is simple since wiring can be eliminated or at least significantly reduced. Regardless, the low-power electronic lock may need to communicate with a central access control server, e.g. for access evaluation, transferring audit logs, location-based access control etc. This can be achieved by a smartphone acting as a router for information between the lock and the central system. The smartphone is also used as a location source when location-based access control is applied.

However, this configuration puts requirements on the smartphone of the user, requiring a specific implementation, e.g. an app, of the smartphone. Moreover, since the user has control over the smartphone, there is a risk of an attacker being able to control the smartphone to provide an incorrect (valid) location to circumvent the location-based access control.

### SUMMARY

One object is to enable a more secure implementation of location-based access control.

According to a first aspect, it is provided a gateway for enabling remote access control by an access control server for an electronic lock; wherein the gateway is configured to be mounted within short-range communication distance to the electronic lock; wherein the gateway is free from being associated with a particular user or key. The gateway comprises: a battery being a power source for the gateway; a short-range radio communication module for communicating with the electronic lock; a communication module for communicating with the access control server; a location determination module; a processor; and a memory storing instructions that, when executed by the processor, cause the gateway to: transmit uplink location data to the access control server, which comprises to obtain first location data from the location determination module, wherein the uplink location data comprises the first location data; receive an unlock message from the access control server; transmit an unlock command to the electronic lock; and transition from the active state to the low-power state.

The battery may be the only power source for the gateway.

The gateway may further comprise instructions that, when executed by the processor, cause the gateway to: receive a wakeup signal from the electronic lock; and transition from a low-power state to an active state.

The instructions to transmit location data may comprise instructions that, when executed by the processor, cause the gateway to obtain second location data from the communication module, wherein the uplink location data comprises also the second location data.

The location determination module may be a satellite-based location determination module.

The location determination module may be based on any of GPS, Global Positioning System, GLONASS, Global'naya Navigatsionnaya Sputnikovaya Sistema, BeiDou, Galilei or Starlink.

The cellular communication module may be configured to communicate using LTE M, Long-Term Evolution Machine-type communication, or using NB-IoT, Narrowband Internet of Things.

According to a second aspect, it is provided a method for enabling remote access control by an access control server for an electronic lock, the method being performed in a battery-powered gateway that is configured to be mounted within short-range communication distance to the electronic lock, wherein the gateway is free from being associated with a particular user or key. The method comprises: transmitting uplink location data to the access control server over a communication module for communicating with the access control server, which comprises obtaining first location data from a location determination module of the gateway, wherein the uplink location data comprises the first location data; receiving an unlock message from the access control server over a communication module for communicating with the access control server; transmitting an unlock command to the electronic lock; and transitioning from the active state to the low-power state.

The method may further comprise: receiving a wakeup signal from the electronic lock over a short-range radio communication module for communicating with the electronic lock; and transitioning from a low-power state to an active state.

The transmitting location data may comprise obtaining second location data from the communication module, wherein the uplink location data comprises also the second location data.

The location determination module may be a satellite-based location determination module.

The location determination module may be based on GPS, Global Positioning System.

The cellular communication module may be configured to communicate using LTE M, Long-Term Evolution Machine-type communication, or using NB-IoT, Narrowband Internet of Things.

According to a third aspect, it is provided a computer program enabling remote access control by an access control server for an electronic lock, the based on a battery-powered gateway that is configured to be mounted within short-range communication distance to the electronic lock, wherein the gateway is free from being associated with a particular user or key. The computer program comprises computer program code which, when executed on a gateway causes the gateway to: transmit uplink location data to the access control server over a communication module for communicating with the access control server, which comprises obtaining first location data from a location determination module of the gateway, wherein the uplink location data comprises the first location data; receive an unlock message from the access control server over a communication module for communicating with the access control server; transmit an unlock command to the electronic lock; and transition from the active state to the low-power state.

According to a fourth aspect, it is provided a computer program product comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a state diagram illustrating power states of the gateway of FIG. 1 according to one embodiment;

FIG. 3 is a sequence diagram illustrating communication between some of the various entities of FIG. 1;

FIG. 4 is a flow chart illustrating embodiments of methods enabling remote access control by an access control server for an electronic lock;

FIG. 5 is a schematic diagram illustrating components of the gateway of FIG. 1;

FIG. 6 shows one example of a computer program product comprising computer readable means;

FIG. 7 is a schematic diagram illustrating an environment in which a second set of embodiments presented herein can be applied;

FIG. 8 is a sequence diagram illustrating communication between some of the various entities of FIG. 7; and

FIG. 9 is a flow chart illustrating the second set of embodiments of methods enabling remote access control by an access control server for an electronic lock.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, a battery-powered gateway is provided by an electronic lock. The gateway communicates over short-range communication with the electronic lock. Furthermore, the gateway communicates over a wide area network (e.g. cellular, satellite, Wi-Fi, etc.) with a central access control server. In order to save power, the gateway is normally in a low-power state. Significantly, the gateway contains no credentials to open the electronic lock and is separate from any key device, and can thus securely be installed in the immediate vicinity of the electronic lock. The gateway also contains a location determination module (e.g. based on GPS), providing location data. The location data from the gateway is used as one factor in authentication for unlocking the electronic lock. Since the location data originates from the gateway, rather than e.g. a smartphone of the user, the location data is much more difficult to manipulate by an attacker, e.g. to incorrectly indicate a valid location when the gateway is in an invalid location for the location-factor of the authentication.

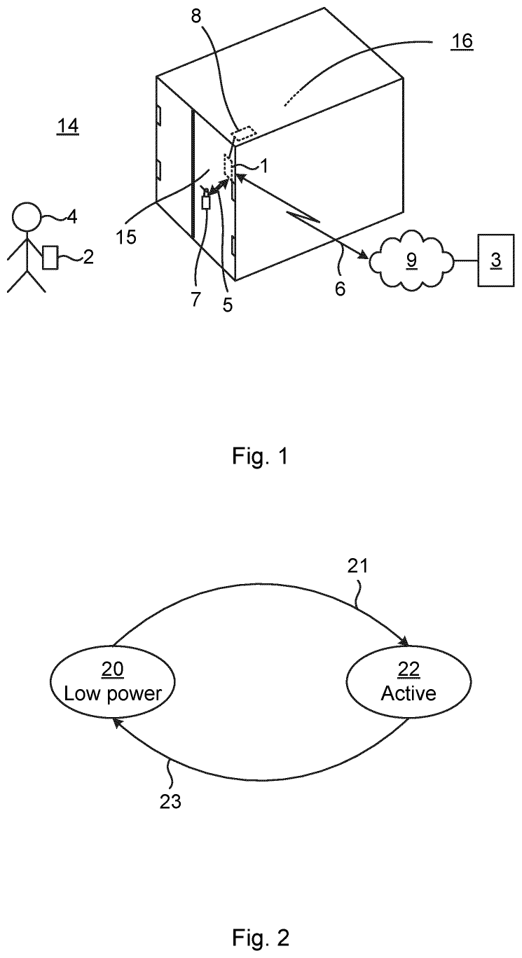

FIG. 1 is a schematic diagram illustrating an environment in which embodiments presented herein can be applied. Access to a physical space 16 is restricted by an openable physical barrier 15, which is selectively unlockable. The openable physical barrier 15 stands between the restricted physical space 16 and an accessible physical space 14. In this example, the restricted physical space 16 is the inside a shipping container. However, the restricted physical space 16 can be any suitable physical space for which it is desired to control access. The restricted physical space 16 is inside the barrier 15 and the accessible physical space 14 is outside the barrier 15. The openable physical barrier 15 can be a door, gate, turnstile, hatch, window, drawer, etc. The barrier 15 is provided in a surrounding fixed structure 11, such as a wall or fence.

In order to unlock or lock the barrier 15, an electronic lock 7 is provided. The electronic lock 7 can be battery-powered for convenient installation, also in locations where electric power is not reliably available, e.g. in a shipping container. It is to be noted that the electronic lock 7 can be any type of lock, e.g. a padlock (as shown), mounted in the fixed structure 11 by the physical barrier 15, or in the physical barrier 15 itself.

A user 4 approaches the lock to gain access to the restricted physical space 16, as explained in more detail below. The user carries a user device 2, e.g. a conventional mobile phone or a smartphone. An access control server 3 is provided in a remote location for evaluating whether the user 4 should be granted or denied access. When access is granted, the access control server 3 sends an unlock message to a gateway, which sends an unlock command to the electronic lock 7.

The gateway 1 can be battery-powered and enables communication between the electronic lock 7 and the access control server 3. Alternatively, the gateway 1 can be externally powered, e.g. from a vehicle or similar. The gateway 1 comprises a short-range radio communication module (61 of FIG. 5) for communicating with the electronic lock 7 over a short-range communication link 5. The short-range radio communication link can be based on e.g. Bluetooth Low Energy (BLE), Bluetooth, UHF, ZigBee, any of the IEEE 802.11 standards, any of the IEEE 802.15 standards, etc.

The gateway 1 further comprises a communication module (62 of FIG. 5) for communicating with the access control server 3 over communication link 6 to a wide area network 9, such as the Internet. The communication link 6 can be based on cellular communication, such as a low-power cellular interface, such as LTE M (Long-Term Evolution Machine-type communication) or NB-IoT (Narrowband Internet of Things) to keep the power requirements for the gateway 1 low.

The gateway 1 also comprises a location determination module, providing location data that can be used by the access control server 3 as one factor in the access evaluation. For instance, when the electronic lock 7 is provided to secure a shipping container, the access control server 3 can be configured to (as one factor) only allow opening of the electronic lock 7 when the gateway is located within a predefined valid area, e.g. a particular harbour.

When provided in the context of the gateway 1 can have an antenna 8 provided on the outside of the shipping container (or antenna elements both on the inside and the outside of the shipping container.

Optionally, the electronic lock 7 and the gateway 1 form a lock system 10. The lock system 10 can be provided as a single device.

FIG. 2 is a state diagram illustrating power states of the gateway 1 of FIG. 1 according to one embodiment. There is a low-power state 20 and an active state 22.

In the low-power state 20, the gateway 1 consumes very little power. For instance, the gateway can be in a sleep mode, where it is powered off, thus saving power, except for components that are needed for receiving a wakeup signal.

In the active state 22, the gateway 1 is powered up and can perform its normal operational tasks.

To transition 21 from the low-power state 20 to the active state, the gateway receives a wakeup signal, e.g. from the electronic lock 7. The wakeup signal can e.g. be in the form of a suitable BLE signal, such as an OOK (on-off keying) signal.

The transition 23 from the active state 22 can e.g. be based on an inactivity timer expiring, indicating that the gateway has not been active during the timer period. In this way, the gateway falls back to the low-power state 20 whenever possible to save power.

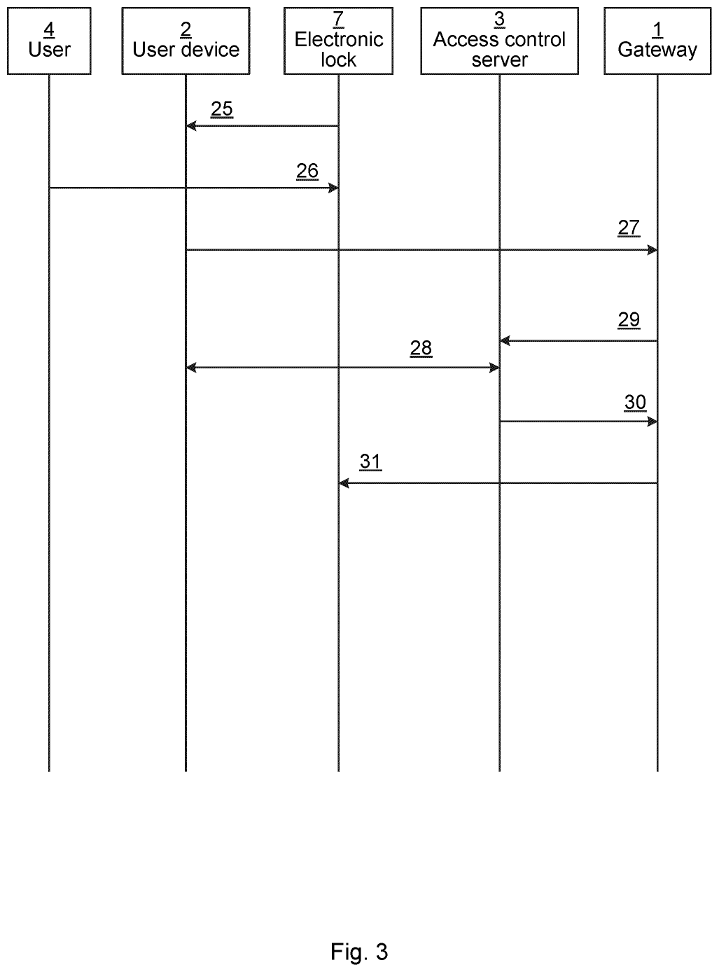

FIG. 3 is a sequence diagram illustrating communication between some of the various entities of FIG. 1. This communication is used for access control and other purposes.

When the user 4 approaches the electronic lock 7, the user obtains an identifier 25 of the electronic lock 7. This can be obtained by manually reading a number or alphanumeric string shown by or on (and being associated with) the electronic lock 7. Alternatively, the user device 2 of the user 4 can read an optical code or NFC (Near-field communication)/RFID (Radio-frequency identification) tag provided by (and being associated with) the electronic lock to thereby get an identifier of the electronic lock 7. Alternatively, the user device 2 of the user 4 connects with the electronic lock 7 using BLE to obtain the identifier 25 of the electronic lock 7.

The user also causes the electronic lock 7 to wake up 26, e.g. by pressing a button on the electronic lock 7, which triggers the electronic lock 7 to wake up.

Once the electronic lock 7 is active, the electronic lock 7 sends a wakeup signal 27 to the gateway 1, causing the gateway 1 to wake up, i.e. to transition from the low-power state to the active state.

When in the active state, the gateway 1 determines its location, e.g. using GPS and provides uplink location data 29 based on the determined location to the access control device.

The access control server 3 evaluates access at least based on the uplink location data 29. Optionally, the access control server 3 also evaluates access based on device authentication of the user device 2 and/or user input authentication (e.g. user input into the user device 2 or the electronic lock 7).

In one embodiment, the access control server 3 authenticates 28 the user device 2 by the user 4 causing the user device 2 to send a text message (e.g. using SMS, short messaging service) to the access control server 3, as a form of two-factor authentication, since the location data is used as one factor for authentication. The access control server 3 can be configured to mandate two-factor authentication. The text message contains an identity of the lock. The instructions for this procedure (including the phone number to send the text message to) can be posted in plain text by the electronic lock 7, e.g. on a shipping container, for the user 4 to read and follow. Using this type of authentication, the requirements on the user device 2 are very low; it is sufficient that the user device 2 is capable of sending text messages. Hence, a traditional mobile phone can be used as the user device 2 and there are no requirements on any particular software or application on the user device 2. The access control server 3 can authenticate the user 4 and authorise access based on the transmitter identity of the text message. Alternatively, an app or browser in the user device 2 can read the optical code or tag by the lock and communicate with the access control server 3 for authentication and authorisation.

Once access is granted by the access control server 3, the access control server 3 looks up the gateway 1 associated with the electronic lock 7 and creates an unlock message 29 for the gateway 1. The unlock message can be stored in a message queue for the gateway 1. The unlock message 29 comprises an indication of the lock to be unlocked. The gateway receives the unlock message 29, e.g. by polling the message queue at the access control server 3.

Alternatively, the access control server 3 sends the unlock message 29 to the gateway 1 without any need for the gateway 1 to poll a message queue.

Once the unlock message 29 has been received for the particular electronic lock 7, the gateway 1 transmits a corresponding unlock command 30 to the electronic lock 7. Optionally, the content of the unlock command 30 is identical to (or comprises) the content of the unlock message 29. The electronic lock 7 then unlocks, allowing the user 4 to enter the restricted space.

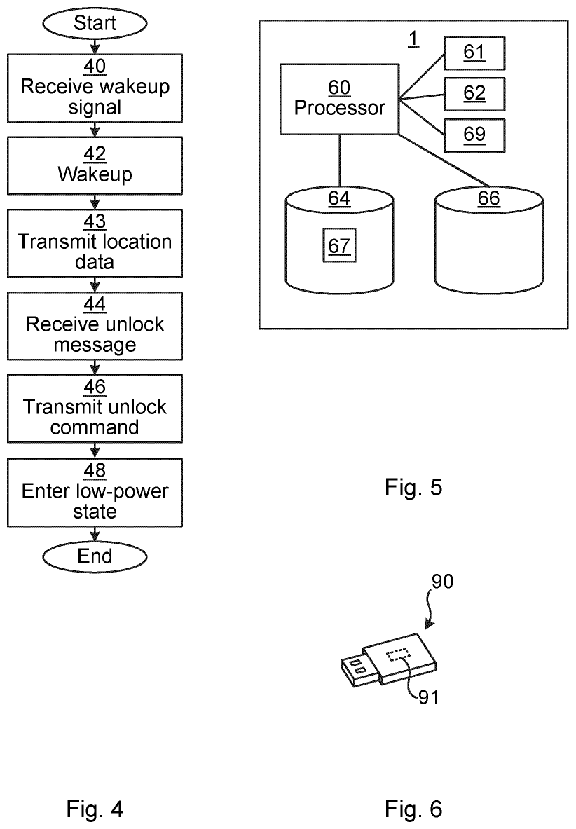

FIG. 4 is a flow chart illustrating embodiments of methods enabling remote access control by an access control server 3 for an electronic lock 7. The method is performed in an (at least partly) battery-powered gateway 1 that is configured to be mounted within short-range communication distance to the electronic lock. Moreover, the gateway is free from being associated with a particular user or key.

In an optional receive wakeup signal step 40, the gateway 1 receives a wakeup signal from the electronic lock 7 over a short-range radio communication module 61 (of the gateway) for communicating with the electronic lock. In one embodiment, the wakeup signal is a BLE signal (OOK signal) that wakes up the gateway.

In an optional wake up step 42, the gateway 1 transitions from a low-power state 20 to an active state 22. This allows the gateway to be fully active, e.g. to transfer data between the electronic lock 7 and the access control server 3.

In a transmit uplink location data step 43, the gateway 1 transmits uplink location data to the access control server 3. The uplink location data is transmitted over a communication module 62 (of the gateway) for communicating with the access control server (3). This step comprises obtaining first location data from a location determination module 69 of the gateway 1, such that the uplink location data comprises the first location data.

Optionally, this step comprises obtaining second location data from the communication module 62. In this case, the uplink location data also comprises also the second location data (in addition to the first location data). The communication module 62 can obtain the second location data based on any suitable cellular network localisation technology, e.g. based on base station triangulation, cellular network-based localisation, etc. By providing also the second location data, there is even less of a risk of an attacker being able to spoof the location determination.

In a receive unlock message step 44, the gateway 1 receives an unlock message from the access control server 3 over a communication module 62 (of the gateway) for communicating with the access control server 3.

In a transmit unlock command step 46, the gateway 1 transmits an unlock command to the electronic lock 7. Optionally, the content of the unlock command 30 contains at least part of the content of the unlock message 29, comprising a cryptographic signature of the access control server 3, and/or the content is encrypted for the electronic lock 7.

In an enter low-power state step 48, the gateway 1 transitions from the active state 22 to the low-power state 20. This can occur based on an inactivity timer expiring, whereby the gateway returns to the low-power state to save power after the gateway 1 is inactive longer than the period defined by the timer.

Using the embodiments presented herein, location-based authentication is enabled where the location is based on the gateway. Hence, it is significantly difficult for an attacker to manipulate location data that is used for the location-based access control. Moreover, the location determination can be used to allow the access control server 3 to centrally store location data on each gateway 1 (and thus associated electronic lock 7), to track the location of each electronic lock 7. When a new location reading is in an unexpected place, this can trigger an alarm or other security event.

FIG. 5 is a schematic diagram illustrating components of the gateway of FIG. 1. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIG. 4 above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM. Both the data memory 66 and the memory 64 comprising the software instructions 67 can optionally be divided into logical security partitions, to ensure that wireless protocols do not have access to location or gateway core functionality.

The gateway 1 further comprises a short-range radio communication module 61 for communicating with the electronic lock 7 and a communication module 62 for communicating with the access control server 3. There may be other I/O interfaces for communicating with external and/or internal entities.

The gateway 1 also comprises a location determination module 69, which can e.g. be a satellite-based location determination module, such as GPS (Global Positioning System), GLONASS (Global'naya Navigatsionnaya Sputnikovaya Sistema), BeiDou, Galilei or Starlink. Alternatively or additionally, the location determination module is based on a beacon-based localisation, such as based on Bluetooth (or BLE) beacons. As explained above, the localisation is optionally also based on be based on location determination from the cellular network, in cooperation with the communication module 62. Other localisation technologies can also be applied, such as (BLE) beacon-based localisation.

Other components of the gateway 1 are omitted in order not to obscure the concepts presented herein.

FIG. 6 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 5. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

As mentioned, locks and keys are evolving from the traditional pure mechanical locks. These days, electronic locks are becoming increasingly common. For electronic locks, no mechanical key profile is needed for authentication of a user. The electronic lock can be opened on command from a remote access control server, or the electronic lock can be opened using an electronic key stored on a special carrier (fob, card, etc.) or in a smartphone. Such electronic locks provide a number of benefits, including improved flexibility in management of access rights, audit trails, key management, etc.

There are battery-powered electronic locks that have additional advantages. Installation is simple since wiring can be eliminated or at least significantly reduced. The electronic lock may need to communicate with a central access control server, e.g. for access evaluation, transferring audit logs, etc. This can be achieved by a smartphone acting as a router for information between the lock and the central system.

However, this communication puts requirements on the smartphone of the user, requiring a specific implementation, e.g. an app, of the smartphone.

One object is to provide a way for an electronic lock to communicate with an access control server without relying on user equipment for such communication.

According to a second set of embodiments presented herein, a battery-powered gateway is provided in the proximity of an electronic lock. The gateway communicates over short-range communication with the electronic lock. Furthermore, the gateway communicates over a cellular network with a central access control server. In order to save power, the gateway is normally in a low-power state. Significantly, the gateway contains no credentials and is separate from any key device, and can thus securely be installed in the immediate vicinity of the electronic lock. When a user approaches the electronic lock, the user causes the electronic lock to be activated, which causes the electronic lock to send a wakeup signal to the gateway. Using a separate communication (i.e. without using the gateway), the user/key authenticates with the access control server. When the access control server grants access, the access control server sends an unlock message to the gateway, which, in turn, sends an unlock command to the electronic lock. Thereafter, the gateway can return to the low-power state. In this way, network connectivity is provided to the electronic lock that does not rely on any user device. Due to the particular way of managing transitions between low-power state and active state, the gateway can be battery-powered, while still providing predictable online connectivity for the electronic lock.

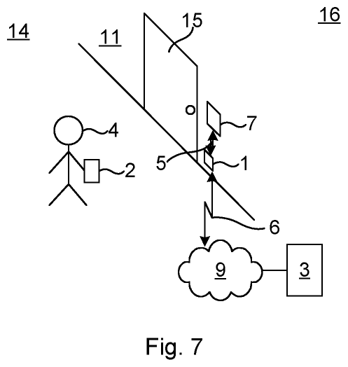

FIG. 7 is a schematic diagram illustrating an environment in which the second set of embodiments presented herein can be applied. Access to a physical space 16 is restricted by an openable physical barrier 15, which is selectively unlockable. The openable physical barrier 15 stands between the restricted physical space 16 and an accessible physical space 14. Note that the accessible physical space 14 can be a restricted physical space in itself, but in relation to this particular barrier 15, the accessible physical space 14 is accessible. In other words, the restricted physical space 16 is inside the barrier 15 and the accessible physical space 14 is outside the barrier 15. The openable physical barrier 15 can be a door, gate, turnstile, hatch, window, drawer, etc. The barrier 15 is provided in a surrounding fixed structure 11, such as a wall or fence.

In order to unlock or lock the barrier 15, an electronic lock 7 is provided. The electronic lock 7 can be battery-powered for convenient installation, also in inhospitable locations. It is to be noted that the electronic lock 7 can be mounted in the fixed structure 11 by the physical barrier 15 (as shown) or in the physical barrier 15 itself (not shown).

A user 4 approaches the lock to gain access to the restricted physical space 16, as explained in more detail below. The user carries a user device 2, e.g. a conventional mobile phone or a smartphone. An access control server 3 is provided in a remote location for evaluating whether the user 4 should be granted or denied access. When access is granted, the access control server 3 sends an unlock message to a gateway 1, which sends an unlock command to the electronic lock 7.

The gateway 1 is battery-powered and enables communication between the electronic lock 7 and the access control server 3. The gateway 1 comprises a short-range radio communication module (61 of FIG. 5) for communicating with the electronic lock 7 over a short-range communication link 5. The short-range radio communication link can be based on e.g. Bluetooth Low Energy (BLE), Bluetooth, UHF, ZigBee, any of the IEEE 802.11 standards, any of the IEEE 802.15 standards, etc.

The gateway 1 further comprises a cellular radio communication module (62 of FIG. 5) for communicating with the access control server 3 over a cellular communication link 6 to a wide area network 9, such as the Internet. The cellular communication link 6 can be based on a low-power cellular interface, such as LTE M (Long-Term Evolution Machine-type communication) or NB-IoT (Narrowband Internet of Things) to keep the power requirements for the gateway 1 low.

The power states of FIG. 2 are also applicable to the gateway 1 of the second set of embodiments described with reference to FIG. 7.

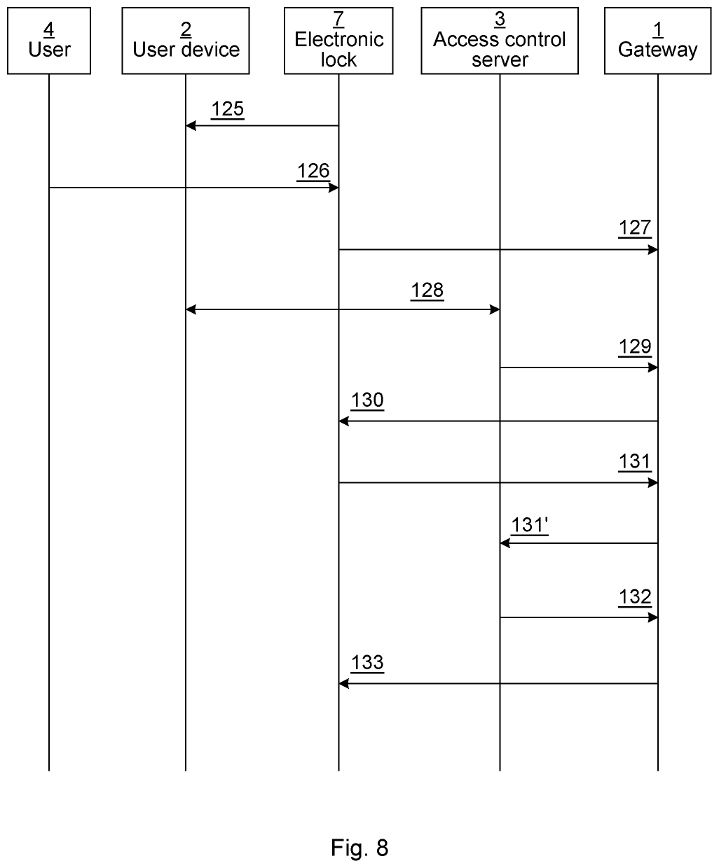

FIG. 8 is a sequence diagram illustrating communication between some of the various entities of FIG. 7. This communication is used for access control and other purposes.

When the user 4 approaches the electronic lock 7, the user obtains an identifier 125 of the electronic lock 7. This can be obtained by manually reading a number or alphanumeric string shown by (and being associated with) the electronic lock 7. Alternatively, the user device 2 of the user 4 can read an optical code or NFC (Near-field communication)/RFID (Radio-frequency identification) tag provided by (and being associated with) the electronic lock to thereby get an identifier of the electronic lock 7.

The user also causes the electronic lock 7 to wake-up 126, e.g. by manipulating a handle of the door secured by the lock, which can trigger the electronic lock 7 to wake-up, by closing a switch or by causing an energy-harvesting device to convert mechanical energy of the handle manipulation to electric energy for the electronic lock. Alternatively, the user can push a physical wake-up button provided by the electronic lock 7 that causes the electronic lock 7 to wake up.

Once the electronic lock 7 is active, the electronic lock 7 sends a wakeup signal 127 to the gateway 1, causing the gateway 1 to wake up, i.e. to transition from the low-power state to the active state.

Furthermore, the access control server 3 authenticates 128 the user device 2. This can e.g. be performed by the user 4 causing the user device 2 to send a text message (e.g. using SMS, short messaging service) to the access control server 3, where the text message contains an identity of the lock. The instructions for this procedure (including the phone number to send the text message to) can be posted in plain text by the electronic lock 7 for the user 4 to read and follow. Using this type of authentication, the requirements on the user device 2 are very low; it is sufficient that the user device 2 is capable of sending text messages. Hence, a traditional mobile phone can be used as the user device 2 and there are no requirements on any particular software or application on the user device 2. The access control server 3 can authenticate the user 4 and authorise access based on the transmitter identity of the text message. Alternatively, an app or browser in the user device 2 can read the optical code or tag by the lock and communicate with the access control server 3 for authentication and authorisation.

Once access is granted by the access control server 3, the access control server 3 looks up the gateway 1 associated with the electronic lock 7 and creates an unlock message 129 for the gateway 1. The unlock message can be stored in a message queue for the gateway 1. The unlock message 129 comprises an indication of the lock to be unlocked. The gateway receives the unlock message 129, e.g. by polling the message queue at the access control server 3.

Alternatively, the access control server 3 sends the unlock message 129 to the gateway 1 without any need for the gateway 1 to poll a message queue.

Once the unlock message 129 has been received for the particular electronic lock 7, the gateway 1 transmits a corresponding unlock command 130 to the electronic lock 7. Optionally, the content of the unlock command 130 is identical to (or comprises) the content of the unlock message 129. The electronic lock 7 then unlocks, allowing the user 4 to enter the restricted space.

Optionally, the electronic lock 7 sends uplink data 131 to the gateway 1. The uplink data 131 can e.g. contain an audit trail, comprising entries for granted and/or or denied access by the electronic lock 7. Optionally, the uplink data 131 can contain a version indicator of firmware that is currently installed in the electronic lock 7. Optionally, the uplink data 131 contains monitoring data for the electronic lock 7 or the environment around the electronic lock 7.

When provided with uplink data 131, the gateway 1 can transmit relevant parts (or all) 131′ of the uplink data 131 to the access control server 3.

When provided with the version indicator of the firmware in the electronic lock, and when there is a new version of firmware available for the electronic lock, the access control server 3 can transmit the new version of the firmware 132 to the gateway 1, that can then provide the new version of the firmware 133 to the electronic lock 7, to be installed in the electronic lock 7.

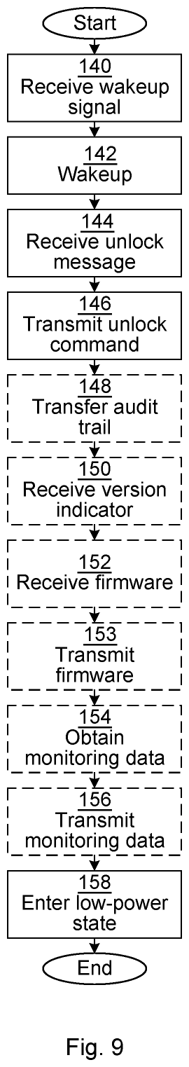

FIG. 9 is a flow chart illustrating the second set of embodiments of methods enabling remote access control by an access control server 3 for an electronic lock 7. The method is performed in a battery-powered gateway 1 that is configured to be mounted within short-range communication distance to the electronic lock. Moreover, the gateway is free from being associated with a particular user or key.

The gateway 1 according to the second set of embodiments comprises the components of FIG. 5 with the exception of the location determination module 69. Further, in the second set of embodiments, the radio communication module 62 is cellular for communicating with the access control server 3. A wake-up radio communication module can also be provided, as a separate entity (not shown) or as part of the short-range radio communication module 61, to allow the gateway 1 to be woken up by an appropriate radio signal, e.g. from the electronic lock. FIG. 6

In a receive wakeup signal step 140, the gateway 1 receives a wakeup signal from the electronic lock 7 over a short-range radio communication module 61 (of the gateway) for communicating with the electronic lock. In one embodiment, the wakeup signal is a BLE signal (OOK signal) that wakes up the gateway.

In a wake up step 142, the gateway 1 transitions from a low-power state 20 to an active state 22. This allows the gateway to be fully active, e.g. to transfer data between the electronic lock 7 and the access control server 3.

In a receive unlock message step 144, the gateway 1 receives an unlock message from the access control server 3 over a cellular radio communication module 62 (of the gateway) for communicating with the access control server 3.

In a transmit unlock command step 146, the gateway 1 transmits an unlock command to the electronic lock 7. Optionally, the content of the unlock command 130 contains at least part of the content of the unlock message 129, comprising a cryptographic signature of the access control server 3, and/or the content is encrypted for the electronic lock 7.

In an optional transfer audit trail step 148, the gateway transfers an audit trail (as part of uplink data) from the electronic lock 7 to the access control server 3. The audit trail comprises entries for granted and/or or denied access by the electronic lock 7.

In an optional receive version indicator step 150, the gateway 1 receives a version indicator of firmware that is currently installed in the electronic lock 7.

In an optional transmit version indicator step 151, the gateway 1 transmits prior to receiving firmware, the version indicator to the access control server 3. This allows the access control server 3 to determine whether there is newer firmware available (i.e. with a later version indicator) that should be installed in the electronic lock 7.

In an optional receive firmware step 152, the gateway 1 receives firmware from the access control server 3. This occurs when the access control server 3 has determined that new firmware should be installed in the electronic lock 7.

In an optional transmit firmware step 153, the gateway 1 transmits the firmware (that was received in step 152) to the electronic lock 7 for installation in the electronic lock 7.

In an optional obtain monitoring data 154, the gateway 1 obtains monitoring data. The monitoring data can be received from the electronic lock and/or can be obtained directly from sensors or internally from the gateway 1. The monitoring data comprising one or more parameters associated with the electronic lock 7 and/or the gateway 1. For instance, the monitoring data can comprise any one or more of: lock status indication, battery level, humidity reading, temperature reading, location indication, altitude, and acceleration readings.

Optionally, the electronic lock and/or the gateway are configured to wake up regularly, collect monitoring data, and provide this data to the gateway 1 for forwarding to the access control server. For instance, the electronic lock and/or gateway can be configured to wake up at the same time every 24 hours to collect and report monitoring data. This allows the access control server to monitor the electronic lock/gateway even when no person is present at the site.

In an optional transmit monitoring data step 156, the gateway 1 transmits the monitoring data to the access control server 3. This allows the access control server 3 to keep track of the electronic lock 7, to determine if any maintenance or repairs should be performed. The transmission of monitoring data can be a separate transmission or can form part of other transmissions, e.g. those in steps 148, 151 or any other transmissions to the access control server 3.

In an enter low-power state step 158, the gateway 1 transitions from the active state 22 to the low-power state 20. This can occur based on an inactivity timer expiring, whereby the gateway returns to the low-power state to save power after the gateway 1 is inactive longer than the period defined by the timer.

Using the second set of embodiments presented herein, an online unlocking procedure is achieved without relying on a smartphone for communication between the lock and the access control server. This enables the lock(s) to communicate with the access control server independently of any users being present in the vicinity of the lock(s), which can be of great importance, particularly for installations where users rarely are present (e.g. installations for power transfer stations, radio base stations, etc.). The installation does not rely on hard-wired power, whereby this can be installed in remote locations, as long as there is mobile network coverage. This reliable connection can thus also be used for monitoring the electronic lock 7 and/or keeping firmware of the electronic lock 7 up to date.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### Itemized List

Item 1. A gateway (1) for enabling remote access control by an access control server (3) for an electronic lock (7);
   wherein the gateway is configured to be mounted within short-range communication distance to the electronic lock;
   wherein the gateway is free from being associated with a particular user or key;
   wherein the gateway (1) comprises:
   a battery (17) being the only power source for the gateway (1);
   a short-range radio communication module (61) for communicating with the electronic lock (7);
   a cellular radio communication module (62) for communicating with the access control server (3);
   a processor (60); and
   a memory (64) storing instructions (67) that, when executed by the processor, cause the gateway (1) to:
   receive a wakeup signal from the electronic lock (7);
   transition from a low-power state (20) to an active state (22);
   receive an unlock message from the access control server (3);
   transmit an unlock command to the electronic lock (7); and
   transition from the active state (22) to the low-power state (20).
Item 2. The gateway (1) according to item 1, further comprising instructions (67) that, when executed by the processor, cause the gateway (1) to:
   transfer, prior to transitioning from the active state (22) to the low-power state (20), an audit trail from the electronic lock (7) to the access control server (3), the audit trail comprising entries for granted and/or or denied access by the electronic lock (7).
Item 3. The gateway (1) according to item 1 or 2, further comprising instructions (67) that, when executed by the processor, cause the gateway (1) to:
   receive firmware from the access control server (3); and
   transmit the firmware to the electronic lock (7) for installation in the electronic lock (7).
Item 4. The gateway (1) according to item 3, further comprising instructions (67) that, when executed by the processor, cause the gateway (1) to:
   receive, prior to receiving firmware, a version indicator of firmware that is currently installed in the electronic lock (7); and
   transmit, prior to receiving firmware, the version indicator to the access control server (3).
Item 5. The gateway (1) according to any one of the preceding items, further comprising instructions (67) that, when executed by the processor, cause the gateway (1) to:
   obtain monitoring data, the monitoring data comprising one or more parameters associated with the electronic lock (7) and/or the gateway; and
   transmit the monitoring data to the access control server (3).
Item 6. The gateway (1) according to item 5, wherein the monitoring data comprises any one or more of: lock status indication, battery level, humidity reading, temperature reading, location indication, altitude, and acceleration readings.
Item 7. A method for enabling remote access control by an access control server (3) for an electronic lock (7), the method being performed by a battery-powered gateway (1) that is mounted within short-range communication distance to the electronic lock, wherein the gateway is free from being associated with a particular user or key, the method comprising:
   receiving (140) a wakeup signal from the electronic lock (7) over a short-range radio communication module (61) for communicating with the electronic lock (7);
   transitioning (142) from a low-power state (20) to an active state (22);
   receiving (144) an unlock message from the access control server (3) over a cellular radio communication module (62) for communicating with the access control server (3);
   transmitting (146) an unlock command to the electronic lock (7); and
   transitioning (158) from the active state (22) to the low-power state (20).
Item 8. The method according to item 7, further comprising:
   transferring (148), prior to transitioning from the active state (22) to the low-power state (20), an audit trail from the electronic lock (7) to the access control server (3).
Item 9. The method according to item 7 or 8, further comprising:
   receiving (152) firmware from the access control server (3); and transmitting (153) the firmware to the electronic lock (7) for installation in the electronic lock (7).
Item 10. The method according to item 9, further comprising:
   receiving (150), prior to receiving firmware, a version indicator of firmware that is currently installed in the electronic lock (7); and
   transmitting (151), prior to receiving firmware, the version indicator to the access control server (3).
Item 11. The method according to any one of items 7 to 10, further comprising:
   obtaining (154) monitoring data, the monitoring data comprising one or more parameters associated with the electronic lock (7) and/or the gateway; and
   transmitting (156) the monitoring data to the access control server (3).
Item 12. The method according to item 11, wherein the monitoring data comprises any one or more of: lock status indication, battery level, humidity reading, temperature reading, location indication, altitude, and acceleration readings.
Item 13. A computer program (67, 91) enabling remote access control by an access control server (3) for an electronic lock (7), based on a battery-powered gateway (1) that is configured to be mounted within short-range communication distance to the electronic lock, wherein the gateway is free from being associated with a particular user or key, the computer program comprising computer program code which, when executed on a gateway (1) causes the gateway (1) to:
   receive a wakeup signal from the electronic lock (7) over a short-range radio communication module (61) for communicating with the electronic lock (7);
   transition from a low-power state (20) to an active state (22);
   receive an unlock message from the access control server (3) over a cellular radio communication module (62) for communicating with the access control server (3);
   transmit an unlock command to the electronic lock (7); and
   transition from the active state (22) to the low-power state (20).
Item 14. A computer program product (64, 90) comprising a computer program according to item 13 and a computer readable means comprising non-transitory memory in which the computer program is stored.

1. A gateway for enabling remote access control by an access control server for an electronic lock, wherein the gateway is configured to be mounted within short-range communication distance to the electronic lock, wherein the gateway is free from being associated with a particular user or key, and wherein the gateway comprises:
a battery being a power source for the gateway;
a short-range radio communication module for communicating with the electronic lock;
a communication module for communicating with the access control server;
a location determination module;
a processor; and
a memory storing instructions that, when executed by the processor, cause the gateway to:
transmit uplink location data to the access control server, the transmitting uplink location data comprising obtaining first location data from the location determination module, wherein the uplink location data comprises the first location data;
receive an unlock message from the access control server;
transmit an unlock command to the electronic lock; and
transition from an active state to a low-power state.

2. The gateway according to claim 1, wherein the battery is the only power source for the gateway.

3. The gateway according to claim 1, wherein the memory further comprises instructions that, when executed by the processor, cause the gateway to:
receive a wakeup signal from the electronic lock; and
transition from the low-power state to the active state.

4. The gateway according to claim 1, wherein the instructions to transmit uplink location data comprise instructions that, when executed by the processor, cause the gateway to obtain second location data from the communication module, wherein the uplink location data also comprises the second location data.

5. The gateway according to claim 1, wherein the location determination module is a satellite-based location determination module.

6. The gateway according to claim 5, wherein the location determination module is based on any one or more of, Global Positioning System (GPS), Global'naya Navigatsionnaya Sputnikovaya Sistema (GLONASS), BeiDou, Galilei, or Starlink.

7. The gateway according to claim 1, wherein the communication module is configured to communicate using Long-Term Evolution Machine-type communication (LTE M) or using Narrowband Internet of Things (NB-IoT).

8. A lock system comprising the gateway according to claim 1 and the electronic lock.

9. A method for enabling remote access control by an access control server for an electronic lock, the method being performed in a battery-powered gateway that is configured to be mounted within short-range communication distance to the electronic lock, wherein the gateway is free from being associated with a particular user or key, the method comprising:
transmitting uplink location data to the access control server over a communication module for communicating with the access control server, the transmitting uplink location data comprising obtaining first location data from a location determination module of the gateway, wherein the uplink location data comprises the first location data;
receiving an unlock message from the access control server over the communication module for communicating with the access control server;
transmitting an unlock command to the electronic lock; and
transitioning from an active state to a low-power state.

10. The method according to claim 9, further comprising:
receiving a wakeup signal from the electronic lock over a short-range radio communication module for communicating with the electronic lock; and
transitioning from the low-power state to the active state.

11. The method according to claim 9, wherein transmitting uplink location data comprises obtaining second location data from the communication module, wherein the uplink location data also comprises the second location data.

12. The method according to claim 9, wherein the location determination module is a satellite-based location determination module.

13. The method according to claim 12, wherein the location determination module is based on, Global Positioning System (GPS).

14. The method according to claim 9, wherein the communication module is configured to communicate using Long-Term Evolution Machine-type communication (LTE M) or using, Narrowband Internet of Things (NB-IoT).

15. A non-transitory computer readable medium storing a computer program enabling remote access control by an access control server for an electronic lock, based on a battery-powered gateway that is configured to be mounted within short-range communication distance to the electronic lock, wherein the gateway is free from being associated with a particular user or key, the computer program comprising computer program code which, when executed on the gateway, causes the gateway to:
transmit uplink location data to the access control server over a communication module for communicating with the access control server, the transmitting uplink location data comprising obtaining first location data from a location determination module of the gateway, wherein the uplink location data comprises the first location data;
receive an unlock message from the access control server over a communication module for communicating with the access control server;
transmit an unlock command to the electronic lock; and
transition from an active state to a low-power state.

16. (canceled)
